(19) United States
(12) Patent Application Publication
(10) Pub. No.: US 2024/0089513 A1
(43) Pub. Date: Mar. 14, 2024

(54) Live Streaming Mobile Application

(71) Applicant: Tierra Cannon, Las Vegas, NV (US)

(72) Inventor: Tierra Cannon, Las Vegas, NV (US)

(21) Appl. No.: 17/944,193

(22) Filed: Sep. 14, 2022

(51) Int. Cl. H04N 21/2187; H04N 21/4788

(52) U.S. Cl. CPC H04N 21/2187; H04N 21/4788

(57) ABSTRACT

Disclosed herein is a method for promoting competition amongst local artists through a mobile application wherein the mobile application is synchronously connected to a TV show. A competition is hosted on the mobile application between a plurality of artists wherein the competition comprises a variety of tasks, challenges and activities. Further, the mobile application provides a medium for the artists to connect with their fans and supporters. Live performances of the artists are viewed on the TV show. Further, the artists perform in major city attraction points and do several activities related to music and promotion of their music band. The mobile application further provides a medium for voting the winner of the competition and the same is displayed on TV channel through a reality show.

### TECHNICAL FIELD

This disclosure relates generally to live streaming over handheld devices, and more particularly, to a mobile application connected synchronously to a TV channel for streaming a reality show.

### BACKGROUND

Entertainment has been one of the major stress busters for humans for long. Be it in form of audio, video or audio-visual performances, such entertainment has been an integral part of human lifestyle. In the recent past, TV reality shows have been very successful and have gained significant viewership among audiences of all age groups. Reality shows are immensely popular since they have unscripted real-life situations, and the participants are unknown or less famous personalities rathe than known professional stars.

However, most of the reality tv shows these days are scripted and focus more on known stars in order to garner subscribers, riding on popularity of participants. None of these TV shows address or rope in less popular but immensely talented underground artists and local city stars. These set of talented artists are often neglected and end up as lost stars in their own local city.

In light of above-mentioned problems, there does not exist a solution that provides a medium to small time artists to showcase their talent in unbiased manner and participate in reality TV shows and at the same time provide a source of entertainment to public.

### SUMMARY

The present disclosure seeks to provide a method for promoting competition amongst local artists through a mobile application wherein the mobile application is synchronously connected to a TV show. A competition is hosted on the mobile application between a plurality of artists wherein the competition comprises a variety of tasks, challenges and activities. Further, the mobile application provides a medium for the artists to connect with their fans and supporters. The mobile application further provides a medium for voting the winner of the competition and the same is displayed on TV channel through a reality show.

Embodiments of the present disclosure substantially eliminate or at least partially address the aforementioned problems.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### OBJECT OF INVENTION

One of the objects of the disclosed invention is to promote small and upcoming artists.

Another object of the present invention is to enable local upcoming artists to meet and participate in a reality TV show.

Yet another object of the present invention is to allow fans and supporters engage in live interactions with the artists so that they get a glimpse of life and struggle faced by the artists.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a block diagram of the components of the present invention as per the present disclosure.

It will be appreciated that the drawings illustrated herein are for representation purposes only and do not intend to limit the scope of the present disclosure, and actual implementation of the present disclosure may be viewed substantially differently.

### DETAILED DESCRIPTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

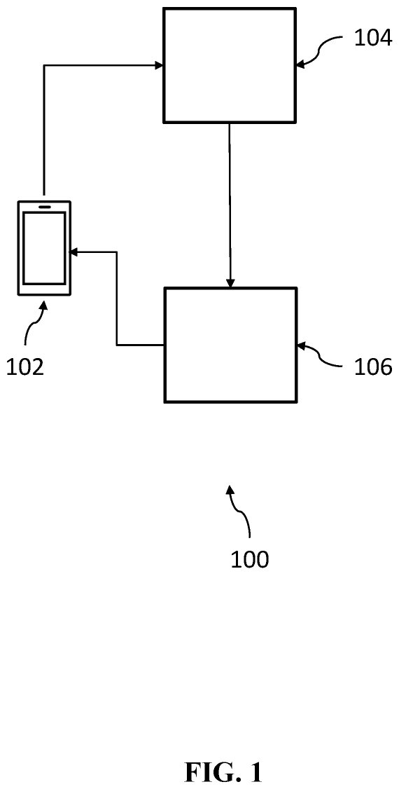

Referring to FIG. 1, the system 100 comprises a mobile application 102 synchronously connected to a processing unit 104. The processing unit is further connected to a live TV server 106 hosting a reality TV show. One or more plurality of artists are connected with one another through the mobile application.

The reality TV show depicts the day-to-day life and struggles of upcoming artists. The TV show is about extremely talented upcoming artists and entrepreneurs with a vision to take over the entertainment industry through the creation and creativity of the artist's music with the help and involvement of fans and supporters.

The present invention provides a method for the plurality of artists to meet and participate in a competition amongst themselves through a mobile application. The competition amongst the plurality of artists can be at a city level or district level. The winner of competition at city level competes with another city level winner. The competition includes a variety of challenges, live shows, tasks, battles and activities amongst the participants. The artists shall be captured live throughout the competition by the mobile application and the TV show. This results in highlighting the struggles and efforts every artist has gone through in the competition. This will ultimately help the audience to determine the winner of the competition as well as increase the fan base and support for the artist.

The mobile application further comprises a profile section wherein each of the plurality of artists can maintain their information including pictures, videos, contact information. The artists can add/delete people and delete comments on their page. The profile page of the artist on the mobile application has a profile pic, a background pic, artist name, artist username, citystar bucks' amount, citystar power amount and city star wallet amount. The city start wallet is used for live stream payment from gifts. Further, the artist can use citystar wallet to purchase citystar bucks. Real money can be added to the city star wallet which is then used to purchase citystar bucks. City start bucks is the virtual currency for the mobile application which is used to buy gifts. The artists must link their social media accounts to the profile page. The profile section further displays the content stats such as how many tracks posted, follower/following numbers, how many #battles, #collabs, #music videos, #contests, solo rank, battle rank, #battle, #battles won, accomplishments, ASK TO COLLAB, ASK TO BATTLE, how many plays on each track (only show the artist)/how many likes on each track/how many comments on each track etc . . . , how many citystars (crowns), how many citystar bombed content, chat button, see your stats (not for non premium users), invite a friend button, Record first Collabs, Record first battle, page views, page plays, page description, location, crew/squad name, social media icon links, artist published content example: tracks, music vid, etc.

The mobile application allows artists to upload audio tracks and beats. Further, the mobile application allows the artists to upload live videos to their profile section. Live videos by artists can be used for gaining support and gifts/donations from audience as well as earn money.

The mobile application provides a plurality of categories under which content can be posted by the artist on their profile page. All the content posted by the artist is categorized into one of the plurality of category labels such as Tracks/Beats, Battles, Collabs, Videos, Music Videos, Live Streams, videos & Pictures. A visitor to profile page of the artist can find appropriate content under the said categories.

In yet another aspect, each artist status is categorized amongst one of —CityStarNewbie— —CityStarSpark— —CityStarVet— —CityStarOfTheApp— —TheCityStarGoat!!!. The current status is reflected on the profile page of the artist.

The mobile application includes a list of top performers in each category of tasks such as music, games, live shows, battles, overall rankings etc. Further, the mobile application comprises a section called City Star of the month where the top rankers are listed. Few of the mentions on the mobile application are as follows:
City star of the month—Shows top artist of the month
City stars of the week—Shows top artist of the week
Face of the app/show—Top Artists of tv show and app
city Star of the App—Top Artists on app

One or more artists are selected for the TV show based on the ranking in the list of top performers. Further, each artists must maintain an active participation on the mobile application in order to be considered for participation in the TV show. In an exemplary embodiment, top performers are selected for participation in the TV show.

In yet another aspect of the present invention, the artists selected for participation in the TV show, based on top performer status must maintain their top performer status even while on the TV show. The artists can be eliminated from the competition in case of loss in performer rankings owing to losing battles, challenges or violation of rules.

The mobile application further allows users to select one or more favorite artists. This enables them to be notified whenever their favorite artist posts any content on the mobile application. Further, the artist profile pages have a follow/unfollow button that can be selected by the profile page visitors.

The mobile application has options for the audience interactions with each of the plurality of artists. The interactions include live chats, both audio and video, with the artists. Further, the interactions include likes and sharing the content related to their favorite artist. Live interaction with the artists helps to gain a different and more personal view of the artists. Through the interactions, the audience becomes much aware of the struggles and efforts taken by each of the artists. This ultimately affects the decision making by audience when they decide the winner of the competition.

Further, the mobile application provides for audience engagement with competition. As an example, without limiting the scope of the disclosure, audience have been provided with option to vote as to which city should go up against which city in the competition. Further, the audience votes for the Artists uploaded music and have the option to review and rate the same. This ensures continuous audience participation throughout the competition.

In yet another embodiment, the audience can provide reviews, ratings on the content posted by the artists. However, in order to rate a particular content, a user will have to listen to the entire content and then the user is presented with a set of questions. The user can rate a content on a scale of 1-5. Further, in some cases, the rating can be granular such as rating the beat, lyrics, collabs, overall song, creativity and the cover art individually on the scale of 1-5.

Further, in another embodiment, the tasks/activities are held in some of the popular attraction around the city that results in promoting travel/tourism of the city and brings the audience and the artist closer to their city.

The mobile application allows other users as well as outsiders to listen to live videos/content and support the artist in form of buying gifts, donations. In one embodiment, outsider can listen to content from artists without making a profile on the mobile application. However, said outsiders accessing the mobile application using a guest profile must provide a payment information in order to buy gifts, access content, donate/support artists. Further, the outsiders must provide a social media account to access the mobile application. Guest can not receive gifts from other users unless they become a member by creating a profile page.

In one of the embodiments of the present invention, a user of the mobile application can be an artist or a non-artist. Non-artists shall not have access to few premium services such live streaming or posting videos/audio tracks. The artists with a premium membership shall have access to all features of the mobile application. The mobile application has an option of trail period before subscribing to the premium membership. The premium membership can be configured a weekly, monthly or yearly. The artist profile page shall have a premium badge on subscribing to premium membership. Premium members shall receive more likes and votes than non-premium members if they show support to other artists.

The mobile application has an information section that displays informational content related to copyright laws, making videos, as well as other artist's experiences on the app and advice from mentors and ambassadors.

Further, the mobile application has a discovery section that identifies the trending content, top and popular content over week and month and includes content from Top artists.

Moreover, the mobile application has a push button to initiate a real time chat between users of the mobile application. The artist can initiate a peer-to-peer chat or a group chat. Moreover, the mobile application has the option to imitate a public chat where all members including guests can join the chat.

The final artist winning the show shall be eligible for cash award at the end of the TV show. Further, there are several other prizes throughout the competition for those who could not be declared winner. These include exposure to mass audience, equipment, copyright information, promotional information and etc. These prizes might help the artists with their career once the TV show ends. Further, the artist can team up with other artists on the mobile application to make crew.

Furthermore, the TV show shall have different genre for each season which prevents it from becoming repetitive. At the end of all seasons, two or more previous season cast members for rappers and other genre are made to compete against each other.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

1. A method for organizing a TV reality show amongst a plurality of artists, the method comprising:
enabling, through a mobile application communicably coupled to a processing unit, one or more artists to participate in a competition;
determining top performing artists based on popularity of the artist among the audience;
hosting a TV show on a TV channel wherein the TV show comprises a competition between top performers of the competition on the mobile application;
declaring a winner of the TV show amongst the artists based on audience feedback.

2. The method of claim 1 wherein the mobile application provides for audience interaction with the one or more artists wherein the interactions include live chats, both audio and video, with the artists.

3. The method of claim 1 wherein the mobile application artists to upload audio tracks, beats and live videos.

4. The method of claim 1 wherein the mobile application provides for audience engagement with the competition.

5. The method of claim 1 wherein the fans and supporters can get a real-life glimpse of struggles faced by the artists during the competition.

6. The method of claim 1 wherein each season of the TV show has a different genre than the previous season.

7. The method of claim 1 wherein one or more previous season winners are pitted against one another in a new season of the TV show.

8. The method of claim 1 wherein the final winner of the TV show is eligible for a cash award.

9. The method of claim 1 wherein the mobile application is connected to live TV show on the TV channel.

10. The method of claim 1 wherein the mobile application has a profile page for each of the plurality of artist.

11. The method of claim 1 wherein the mobile application provides option to user to rate the content posted by the artist.

12. The method of claim 1 wherein the mobile application has a push button to initiate a real time chat between the users.

13. The method of claim 1 wherein the mobile application has a discovery section that identifies top, popular and trending content.

14. The method of claim 1 wherein the mobile application has a information section that displays information content for the artists.

15. The method of claim 1 wherein users can send gifts to artists using citystarbucks on the mobile application.

16. The method of claim 1 wherein non-users of the mobile application are also allowed to send gifts to the artists.

17. The method of claim 1 wherein the tasks/activities of the competition are held in popular tourist spots of the city to enhance popularity of city attractions.

18. The method of claim 1 wherein the mobile application maintains a list of top performing artists.

19. The method of claim 1 wherein the artist's status keeps changing based on real time performances by the artist.

20. The method of claim 1 wherein the artist can be eliminated from the TV show based on violation of rules or change in status of the artist.
